(19) United States
(12) Patent Application Publication
(10) Pub. No.: US 2026/0216845 A1
(43) Pub. Date: Jul. 30, 2026

(54) ADAPTER FOR SPLINE INSTALLATION JIG

(71) Applicant: Tracer Imaging LLC, Ossining, NY (US)

(72) Inventors: Kara D'Angelo, Ossining, NY (US); Jessica Huffman, Wilton, CT (US); Ryan Kelly, Scarsdale, NY (US); Steven M. Spiro, Chappaqua, NY (US)

(73) Assignee: Tracer Imaging LLC, Ossining, NY (US)

(21) Appl. No.: 19/147,127

(22) PCT Filed: Jan. 12, 2024
(86) PCT No.: PCT/US2024/011392

§ 371 Date: Jul. 10, 2025

Related U.S. Application Data
(60) Provisional application No. 63/438,849, filed on Jan. 13, 2023.

(51) Int. Cl. B25B 11/02; B25B 5/14; B44D 3/18

(52) U.S. Cl. CPC B25B 11/02; B25B 5/142; B44D 3/185

(57) ABSTRACT

An adapter is disclosed for a spline installation jig for use in attaching a plurality of splines to frame member to form an assembled frame. The adapter comprises a body that includes a first leg and a second leg formed at a right angle to the first leg. The first and second legs include an elevated first and second end block, respectively. The first and second end blocks include a first and second inner contact surface, respectively. The inner face of the body includes a recessed inner ledge that is disposed at least partially in front of the first and second inner contact surfaces. The corner of the body includes a guide pin holder that is configured to receive a guide pin for locating and holding a flexible substrate that is for placement across the frame member and for capture between the plurality of splines and the frame member.

### CROSS-REFERENCE TO RELATED PATENT APPLICATION

This application is based on and claims priority to U.S. Provisional Patent Application 63/438,849, filed Jan. 13, 2023, the entire contents of which is incorporated by reference herein as if expressly set forth in its respective entirety herein.

### TECHNICAL FIELD

The present disclosure is directed to frame assembly equipment and more particularly, to a spline installation jig that is configured to couple a spline to a frame member, whereby a substrate, such as a canvas, is captured between the spline and the frame member, and further is directed to an adapter for use with the spline installation jig that allows different sized substrates (canvases) and frame members to be used with one universal jig.

### SUMMARY

An adapter is disclosed for a spline installation jig for use in attaching a plurality of splines to a frame member to form an assembled frame (product). The adapter comprises a body having an inner face and an opposite outer face. The body includes a first leg and a second leg formed at a right angle to the first leg. The first and second legs meet in a corner of the body, with the first leg including an elevated first end block and the second leg including an elevated second end block. The first end block includes a first inner contact surface and the second end block includes a second inner contact surface. The inner face of the body includes a recessed inner ledge that is disposed at least partially in front of the first and second inner contact surfaces. The corner of the body includes a guide pin holder that is configured to receive a guide pin for locating and holding a flexible substrate that is for placement across the frame member and for capture between the plurality of splines and the frame member.

A system for assembling a frame product that includes a frame member includes: (1) a jig having a center platen surrounding on each side by an adjustable fence, each fence movable between a lowered position and a raised position; and (2) an adapter. The adapter comprises a body having an inner face and an opposite outer face. The body includes a first leg and a second leg formed at a right angle to the first leg. The first and second legs meet in a corner of the body, with the first leg including an elevated first end block and the second leg including an elevated second end block. The first end block includes a first inner contact surface and the second end block includes a second inner contact surface. The inner face of the body includes a recessed inner ledge that is disposed at least partially in front of the first and second inner contact surfaces. The corner of the body includes a guide pin holder that is configured to receive a guide pin for locating and holding a flexible substrate that is for placement across the frame member and for capture between the plurality of splines and the frame member.

### BRIEF DESCRIPTION OF THE DRAWING FIGURES

FIG. 1 is a top plan view of a spline installation jig with an adapter;

FIG. 2 is a perspective view of the spline installation jig with the adapter;

FIG. 3 is a side and top perspective view of the adapter;

FIG. 4 is a top plan view of the adapter;

FIG. 5 is a first end view of the adapter;

FIG. 6 is a second end view of the adapter;

FIG. 7 is a top plan view of a spline installation jig with the adapter showing a loose piece of canvas; and

FIG. 8 is a top plan view of a spline installation jig with the adapter showing a completed frame product.

### DETAILED DESCRIPTION OF CERTAIN EMBODIMENTS

The present application is related to US patent publication No. 2020/0297134, ('134 publication) which is hereby expressly incorporated by reference in its entirety.

### Jig 100

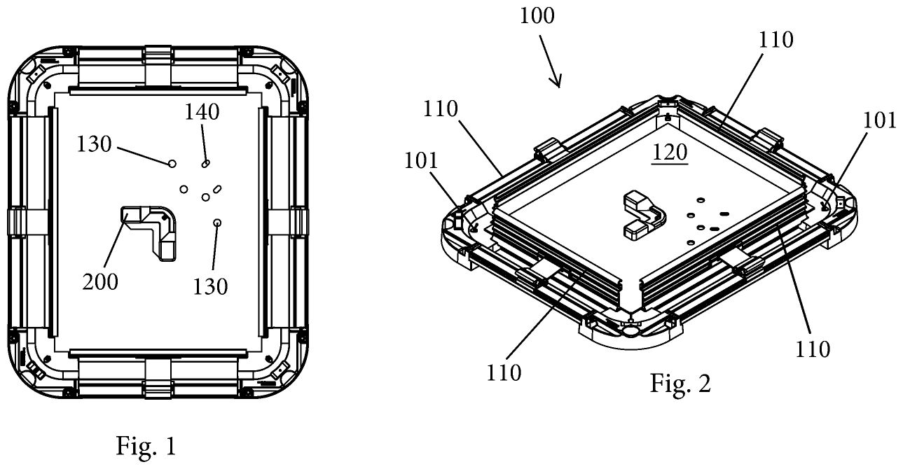

The '134 publication discloses a spline installation fixture which can also be referred to a spline installation jig. The spline installation jig in the '134 publication is illustrated in FIG. 1 and identified by reference character 100. The jig 100 can be the same type that is disclosed in the '134 publication or can be similar in nature.

Since the jig 100 is described in great detail in the '134 publication, it will only be described in general terms in the present application. The spline installation jig 100 is a tabletop assembly aid that includes four fences 110, each of which can be separately raised into a vertical position and then lowered. The jig 100 is used to hold and secure a preassembled frame member 20 (e.g., formed of four joined rails) as splines 22 are inserted into the rails of the frame member 20 to form the completed frame product 10 as illustrated in FIG. 8. As this wedging action often requires considerable mechanical force to ensure secure assembly, the jig 100 also includes engagement features for a tool that imparts substantial force, without the noise, damage, or danger implicit in any impact tool.

One of the limitations of the jig 100 described in the '134 publication is that it was sized to receive and work on one sized substrate. For different sized substrates, different sized jigs were used. It was thus not universal in that it could not be used with multiple sized substrates. The present disclosure overcomes this limitation.

The jig 100 itself has a base or platen 120 which provides a flat base onto which a preassembled frame member 20 may be located for assembly in accordance with the invention. The flat base may be made of metal, acrylic, styrene, polyvinyl chloride (PVC), polycarbonate, acrylonitrile butadiene styrene (ABS), phenolic, or other polymer or resin. The base 120 of the jig 100 includes a plurality of openings and in particular, can include a first set of openings 130 and a second set of openings 140. Each opening 130 can have a different size and/or shape compared to the opening 140. For example, each opening 130 can have a circular shape, while each opening 140 can have an oval shape. As described herein, these openings 130, 140 are designed to locate and hold an adapter 200 which is described below. For example, the adapter 200 can be held within one pair of openings.

### Adapter 200

The adapter 200 is configured to be coupled to and securely positioned along the base 120 of the jig 100 and is designed to position various sized substrates (e.g., canvases 5) along the base 120 as well as position various sized frame members 20 along the base on top of one substrate. In other words, when coupled to the base 120, the adapter 200 cannot freely move along the base 120. As shown, the completed frame product is made up of an assembled frame member 20, which comprises a plurality of rails 22, and a plurality of splines 30 that are attached to the rails 22 to capture the substrate 5 between the plurality of splines 30 and the rails 22 (FIG. 8 and as described in detail in the '134 publication). As mentioned, the jig 100 is designed to smoothly engage the splines 30 with the rails 22.

The adapter 200 can be formed as a single structure made from a suitable material such as a plastic (e.g., the adapter 200 can be an injection molded part).

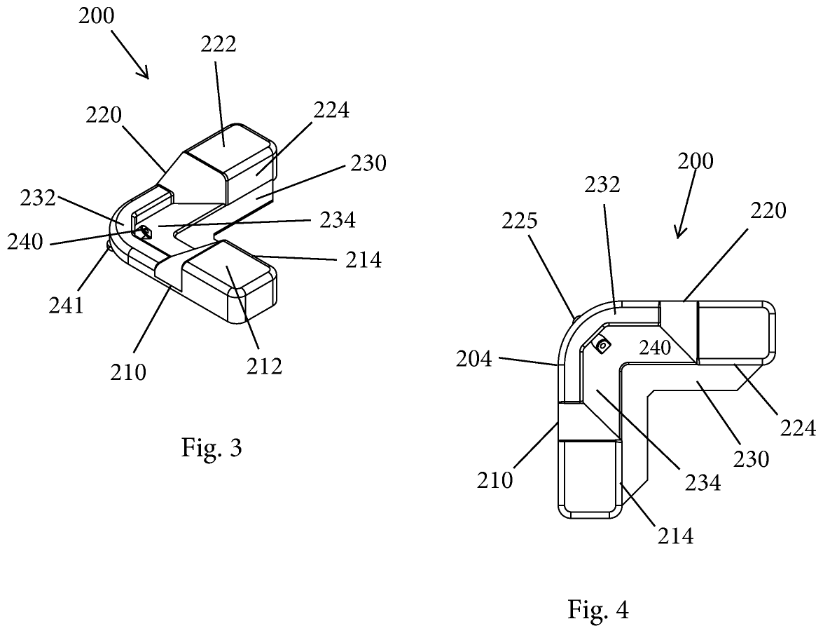

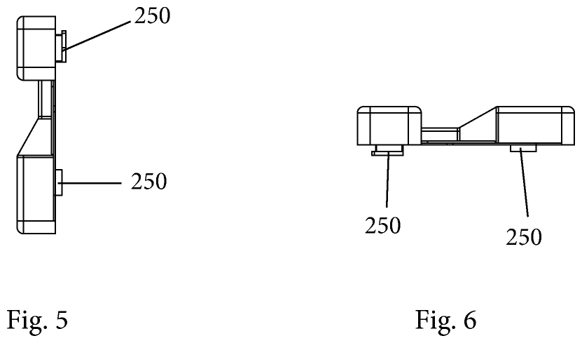

As illustrated in FIGS. 1-6, the adapter 200 is generally L-shaped and defined by a first leg 210 and a second leg 220 that joins the first leg 210 at a right angle in a corner 225 of the adapter 200. The adapter 200 can be symmetric in nature in that the two legs 210, 220 can have the same construction. The adapter 200 has an inner face 202 and an opposite outer face 204.

The first leg 210 is an elongated structure with a first end block 212 formed at its distal end. The first end block 212 includes a first inner contact surface 214 that faces inward. Similarly, the second leg 220 is an elongated structure with a second end block 222 formed at its distal end. The second end block 222 includes a second inner contact surface 224 that faces inward. The first inner contact surface 214 and the second inner contact surface 224 are flat (planar) surfaces that are formed along axes that are perpendicular to one another.

Along the inner face 202, the adapter 200 includes an inner ledge (landing) 230 on which one corner of the assembled frame member 20 sits. The inner ledge 230 has an L-shape but in the illustrated embodiment, the inner ledge 230 does not extend to the ends of the two legs 210, 220 but rather terminates in beveled edges 232 prior to the ends of the two legs 210, 220. As shown, the inner ledge 230 is located in front of the first end block 212 and the second end block 222 and thus the first and second inner contact surfaces 214, 224 are located immediately adjacent to the inner ledge 230 but do not extend thereon. In other words, the rear edge of the inner ledge 230 is coplanar with the first and second inner contact surfaces 214. 224.

The corner 225 is located between the first end block 212 and the second end block 222 and includes a raised outer wall (outer rail) 232 that extends from a section of the first leg 210 around the curved corner to a section of the second leg 220. Between the inner ledge 230 an the raised outer wall 232 there is a corner floor or base surface 234. The corner floor 234 is elevated relative to the inner ledge 230 but is recessed relative to the raised outer wall 232. Like the inner ledge 230, the corner floor 234 is a flat surface. In the middle of the corner 225, there is a pin holder 240 in the form of a hollow protrusion (a boss like structure) that can be integrally formed with the raised outer wall 232 and angled relative thereto. The pin holder 240 can have a cylindrical shape. The pin holder 240 is configured to hold a guide pin that is used to temporarily hold one corner of the substrate 5 in place. The guide pin can be a threaded pin that is received within a threaded hole of the pin holder 240. As described herein, the guide pin is inserted through a hole in the corner of the substrate 5. A bottom end of the pin holder 240 can extend below the raised outer wall 232 so as to define a small first protrusion 241 below the holder 200 in the corner 225 thereof. The first protrusion 241 is configured to be received within one second opening 140 formed in the base 120 of the jig 100 depending upon the size of the frame member and canvas 5.

Along the underside of the holder 200, there are two feet 250 with one foot 250 being located along the underside of the first leg 210 and the other foot being located along the underside of the second leg 220. The side view of FIG. 6 shows the feet 250. The feet 250 are inserted into two selected openings 130 formed in the base 120 of the jig 100. It will be appreciated that the selection of which opening 140 and which openings 130 to use with the adapter 200 depends on the size of the frame member and the substrate (canvas 5). As mentioned, the adapter 200 allows the jig 100 to be universal and allows the jig 100 to work on many different sized frame members and substrates from 4×4 inch to 16×20 inch in one embodiment. Indica can be formed on the base 120 to identify different sets of openings 130, 140 and the corresponding frame sizes. For example, the openings 130, 140 can be color coded and/or text can be provided to assist the user in selecting the proper combination to yield the desired sized frame product 10. As shown, the openings 130, 140 can have different shapes and sizes due to the different objects that are received within these openings 130, 140.

Once the feet 250 and the first protrusion 241 are received in openings 130, 140, the adapter 200 is securely held in place along the base 120 of the jig 100 but is freely removable therefrom. Unintentional movement of the adapter 200 is prevented.

### Assembly of Framed Product

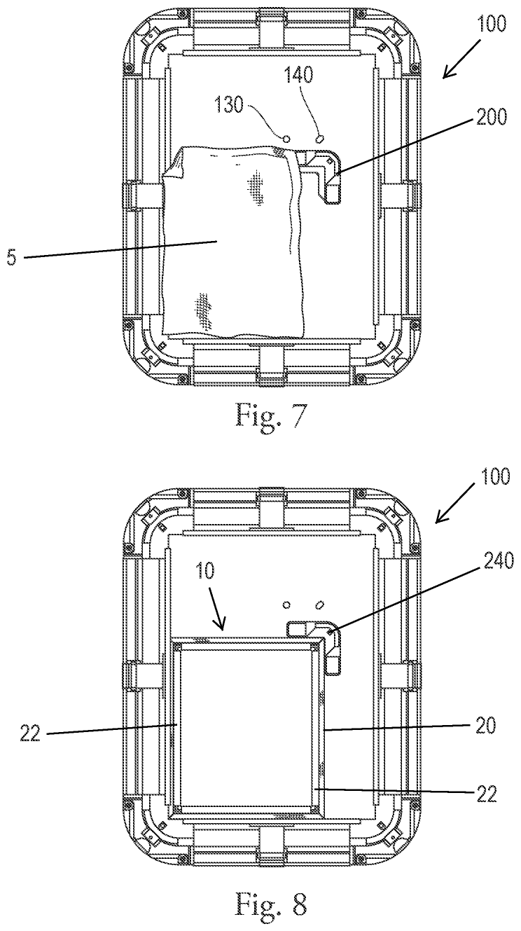

As illustrated in FIGS. 1-8, the framed product is assembled in the following manner. First, the size of the final framed product is determined and then the adapter 200 is inserted into the respective openings 130, 140 that correspond to the selected size of the final framed product. When the adapter 200 is inserted and coupled to the base 120, there are two defined fixed corner structures to locate and hold the canvas 5 and frame member 20. More specifically, one corner of the jig 100 defines one fixed corner and diagonally across from this corner of the jig 100, the adapter 200 defines the other fixed corner. The corner of the jig 100 has a guide pin holder 101 to locate one corner of the canvas and the adapter 200 has the other guide pin holder 240 to locate the diagonally opposite corner of the canvas (substrate).

Once the adapter 200 is inserted into the base 120, the substrate (canvas) 5 is then laid over the base 120 with the guide pin of the jig 100 being inserted through one corner hole formed in the substrate 5 and the guide pin holder 240 of the adapter 200 being inserted through another corner hole formed in the substrate 5. This results in the substrate 5 being loosely held on the base 120. The substrate (canvas) 5 extends into the corner of the adapter 200.

Next, the assembled frame member 20 is placed over the substrate 5. One corner of the frame member 20 is placed (inserted into) on the shallow inner ledge 230 which results in the side walls of the corner of the frame member 20 seating against the first and second inner contact surfaces 214, 224. The adapter 200 thus secures and stabilizes the frame member 20. The diagonally opposite corner of the frame member 20 is stabilized and secured and fixed in place by the jig 100 itself. In particular, this other corner of the frame member 20 seats directly against and within the corner of the jig 100. Now, the frame member 20 is secured in place on the jig with two sides of the frame member 20 seating directly against two working sides of the jig 100. For ease of illustration, these two sides can be described as being a first side and a second side of the frame member 20. Third and fourth sides of the frame member 200 meet within the adapter 20 but are not in direct contact with working sides of the jig 100.

The fences of the jig 100 are raised and engage and lock the first and second sides of the frame member 20 in the manner described in the '134 publication. In particular, the fences clamp down on the rails of the frame member 20 but leave open the channel in the rails that receives the splines 22 (with the canvas 5 being captured therebetween). Next, two splines 22 are locked into place with the two rails of the frame member 20 using the tool described in the '134 publication, thereby capturing the substrate therebetween. Once these two splines 22 are locked in place, the fences are then lowered and the partially assembled product is raised and rotated so that the two unfinished sides of the frame member 20 are positioned against the two working sides of the jig 100. This results in the finished corner now being positioned within the adapter 200. Two additional splines 22 are then inserted into the two open rails (part of the frame member 20) located along the two working sides of the jig 100. Next, two splines 22 are locked into place with the two rails of the frame member 20 using the tool described in the '134 publication, thereby capturing the substrate 5 therebetween. This results in the frame product 10 being completed and then can be removed from the jig 100. In the completed form, the canvas 5 is held taut across the frame member 20.

It will thus be appreciated from the figures, when the jig 100 is in the orientation shown in FIG. 1, it is the left and bottom fences 110 that are used to join two splines 22 to two corresponding rails. In contrast, the right and top fences 110 are not operably since the frame member 20 does not extend thereto in view of the adapter 200 being spaced inward from those two fences.

In addition, it will be appreciated that the adapter 200 is thus designed to create a newly established corner of the jig that is positioned based on the desired size of the final frame product 10. In the illustrated embodiment, the canvas 5 and frame member 10 are only in contact with the lower right corner of the jig, and not the other three corners of the jig 100. However, placement of the adapter 200 creates a new upper right corner for receiving the canvas and frame member. The canvas and frame member thus is secured in place in two corners with one of the corners being defined by the jig and the other corner being defined by the adapter 200. As illustrated, both edges of each of the upper left and lower right corners of the frame member are not secured (e.g., only one edge is secured with the fence).

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art.

Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. An adapter for a spline installation jig for use in attaching a plurality of splines to a frame member to form an assembled frame, the adapter comprising:
a body having an inner face and an opposite outer face, the body including a first leg and a second leg formed at a right angle to the first leg, the first and second legs meeting in a corner of the body, the first leg including an elevated first end block and the second leg including an elevated second end block, the first end block including a first inner contact surface and the second end block including a second inner contact surface, the inner face of the body including a recessed inner ledge that is disposed at least partially in front of the first and second inner contact surfaces, the corner of the body including a guide pin holder that is configured to receive a guide pin for locating and holding a flexible substrate that is for placement across the frame member and for capture between the plurality of splines and the frame member.

2. The adapter of claim 1, wherein the body comprises a single injection molded part.

3. The adapter of claim 1, wherein the body has an L-shape.

4. The adapter of claim 1, wherein the recessed inner ledge has an L-shape.

5. The adapter of claim 1, wherein the body has an attachment means for detachably being coupled to a center base of the jig.

6. The adapter of claim 5, wherein the attachment means comprises at least one foot formed along the underside of the body.

7. The adapter of claim 6, wherein the attachment means comprises a first foot formed along the underside of the first leg and a second foot formed along the underside of the second leg.

8. The adapter of claim 1, wherein the body further includes a guide protrusion that comprises a bottom end of the pin guide holder that is disposed along the underside of the body.

9. The adapter of claim 8, wherein the guide protrusion extends below a bottom of the adapter for reception within an opening of the spline installation jig.

10. The adapter of claim 1, wherein the corner includes a raised rear wall with a corner floor located between the raised rear wall and the recessed inner ledge, the recessed inner ledge being recessed relative to the corner floor.

11. The adapter of claim 1, wherein the first and second inner contact surfaces are coplanar with a rear edge of the recessed inner ledge.

12. The adapter of claim 1, wherein the guide pin holder is a hollow protrusion.

13. The adapter of claim 11, wherein the guide pin holder has inner threads for mating with outer threads on the guide pin.

14. The adapter of claim 9, wherein the guide pin holder extends over the corner floor.

15. The adapter of claim 11, wherein the guide pin holder is formed at an angle less than 90 degrees.

16. A system for assembling a frame product that includes a frame member comprising:
a jig having a center platen surrounding on each side by an adjustable fence, each fence movable between a lowered position and a raised position; and
an adapter that is detachably coupled to the center platen of the jig at selected location thereon, the adapter comprising a body having an inner face and an opposite outer face, the body including a first leg and a second leg formed at a right angle to the first leg, the first and second legs meeting in a corner of the body, the first leg including an elevated first end block and the second leg including an elevated second end block, the first end block including a first inner contact surface and the second end block including a second inner contact surface, the inner face of the body including a recessed inner ledge that is disposed at least partially in front of the first and second inner contact surfaces, the corner of the body including a guide pin holder that is configured to receive a guide pin for locating and holding a flexible substrate that is for placement across the frame member and for capture between the plurality of splines and the frame member.

17. The system of claim 16, wherein the center platen includes a plurality of openings that define different positions that the adapter can be positioned along the center platen to accommodate different sized framed products.

18. The system of claim 17, wherein each fence is configured to engage and hold in place one side of the frame member.

19. The system of claim 17, wherein an underside of the body includes a pair of feet that are received within two openings of the plurality of openings formed in the center platen.

20. The system of claim 19, wherein the plurality of openings includes openings that that are configured to receive a guide protrusion that comprises a bottom end of the pin guide holder that is disposed along the underside of the body.
